(19) United States
(12) Patent Application Publication
(10) Pub. No.: US 2020/0366510 A1
(43) Pub. Date: Nov. 19, 2020

(54) AUTOMATIC EVENT-TRIGGERED CONFERENCE JOIN

(71) Applicant: Microsoft Technology Licensing, LLC, Redmond, WA (US)

(72) Inventors: Eric SEXAUER, Seattle, WA (US); Shalendra CHHABRA, Seattle, WA (US); Lan YE, Redmond, WA (US)

(21) Appl. No.: 16/412,241

(22) Filed: May 14, 2019

(51) Int. Cl. H04L 12/18; H04L 29/06

(52) U.S. Cl. CPC H04L 12/1822; H04L 65/4038; H04L 12/1831

(57) ABSTRACT

A computing system joining a user into an online conference automatically in response to an event. The computing system identifies conference join events that would trigger the user to automatically join into an online conference. During the online conference, in response to the computing system detecting a conference join event for that user, the computing system automatically joins the user into the online conference that is in progress. Potentially, the user may also be provided with appropriate context for the online meeting, which might include a recording or transcript of the online meeting from the point that the conference join event occurred. The user might also be automatically removed from the online conference in response to appropriate other events.

### BACKGROUND

Human beings are a unique species in our ability to communicate one with another. Our ability to effectively share information and mutually exchange ideas contributes to almost every aspect of the advancement and happiness of humankind. Relationships are strengthened. Technological achievement is accelerated. Knowledge and wisdom can be passed from one generation or person to another. We learn from the perspectives, experiences, and knowledge of others. We work more efficiently and collaboratively. Notwithstanding, human beings are imperfect at communicating, and thus ideas are sometimes lost, or misunderstandings can occur. Thus, we sometimes fall short of our full potential.

Computing and network technologies provide additional avenues for sharing information and ideas, thereby increasing the available modalities of communication and information sharing. For instance, we can now participate in and record online meetings and conference to share information and collaborate, even from remote locations. In order to join a meeting, a user typically performs a number of manual steps including potentially installing online conferencing software, navigating to a online conferencing web service, selecting a join control, entering a conference identifier or user credential, and so forth.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

At least some embodiments described herein relate to a computing system joining a user into an online conference automatically in response to an event. The computing system identifies conference join events that would trigger the user to automatically join into an online conference. As examples, the conference join event might be that the user is mentioned, that a particular topic is discussed, that the agenda has reached a certain point, that the user has been summoned into the conference, and so forth. Such events might be designed to bring the user into the online conference when that conference is more relevant to and appropriate for the user, and/or when the user might be a more helpful participant in the online conference.

During the online conference, in response to the computing system detecting a conference join event for that user, the computing system automatically joins the user into the online conference that is in progress. Potentially, the user may also be provided with appropriate context for the online meeting, which might include a recording or transcript of the online meeting from the point that the conference join event occurred. In some embodiments, the user may also be automatically removed from the online conference in response to appropriate other events.

Thus, a user need not take any special action to join an online conference. Furthermore, the user need not participate for the entire online conference. Instead, the user is automatically joined to (and perhaps also automatically removed from) the online conference at an appropriate time. Additionally, if it takes a few moments to join the user into the online conference, the user may be provided with context to bring the user up to speed.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a conferencing environment that includes a conferencing computing system that operates thereon an online conference, to which users may be automatically joined, and from which users may be automatically removed, in accordance with the principles described herein;

FIG. 2 illustrates a flowchart of a method for managing join and remove events for a user, in accordance with the principles described herein;

FIG. 3 illustrates a flowchart of a method for automatically joining a user into an online conference in response to a join event, in accordance with the principles described herein;

FIG. 4 illustrates a flowchart of a method for automatically removing a user from an online conference in response to a remove event, in accordance with the principles described herein; and

FIG. 5 illustrates an example computing system in which the principles described herein may be employed.

### DETAILED DESCRIPTION

At least some embodiments described herein relate to a computing system joining a user into an online conference automatically in response to an event. The computing system identifies conference join events that would trigger the user to automatically join into an online conference. As examples, the conference join event might be that the user is mentioned, that a particular topic is discussed, that the agenda has reached a certain point, that the user has been summoned into the conference, and so forth. Such events might be designed to bring the user into the online conference when that conference is more relevant to and appropriate for the user, and/or when the user might be a more helpful participant in the online conference.

During the online conference, in response to the computing system detecting a conference join event for that user, the computing system automatically joins the user into the online conference that is in progress. Potentially, the user may also be provided with appropriate context for the online meeting, which might include a recording or transcript of the online meeting from the point that the conference join event occurred. In some embodiments, the user may also be automatically removed from the online conference in response to appropriate other events.

Thus, a user need not take any special action to join an online conference. Furthermore, the user need not participate for the entire online conference. Instead, the user is automatically joined to (and perhaps also automatically removed from) the online conference at an appropriate time. Additionally, if it takes a few moments to join the user into the online conference, the user may be provided with context to bring the user up to speed.

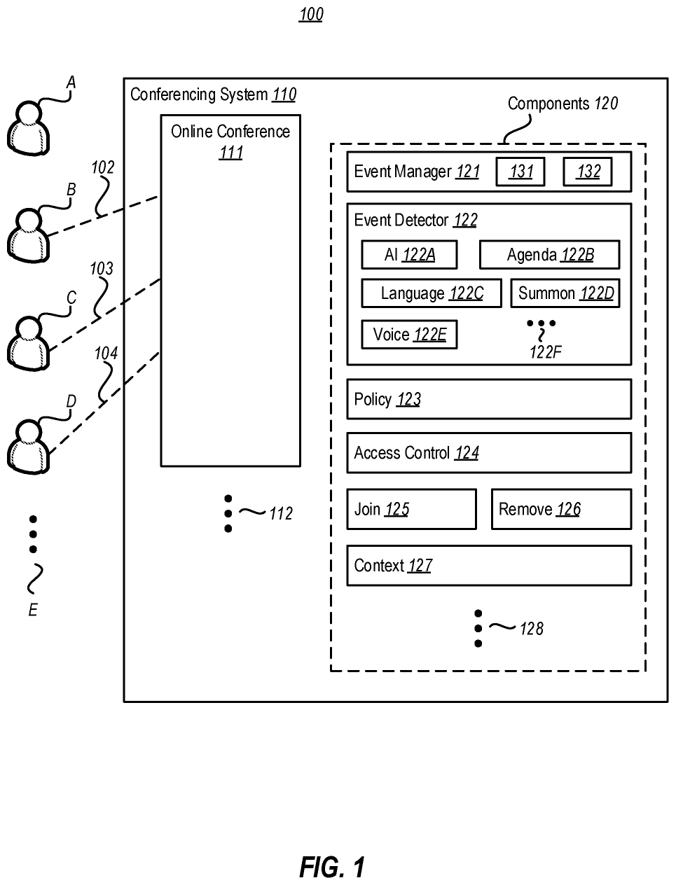

FIG. 1 illustrates a conferencing environment 100 that includes a conferencing computing system 110 that operates thereon an online conference 111. The online conference 111 is a workspace in which various member users who have gained access to the online conference 111 may enjoy one or more modes of communication offered in the workspace. The online conference 111 is modified with the term “online” in that at least one of the modes of communication are enabled by network communication. Thus, some or all of the member users of that online conference 111 may be remote from each other.

As examples, the online conference 111 may permit one member user, some member users, or all member users to present audio content (live and/or recorded), present video content, view audio and/or video content, view and/or add to chat content, view and/or work with shared documents, collaborate in shared editing areas (such as electronic whiteboards, canvases, and editors), and so forth. Potentially, the online conference 111 may permit control to be passed from one member user to another.

The ellipsis 112 represents that the conferencing computing system 110 may operate thereon any number of online conferences, though this description will focus on the online conference 111 as an example. That said, what is said herein for the online conference 111 by way of example, may apply equally to any of the other online conferences that are operated by the conferencing computing system 110. The ellipsis 112 also represents that the number and identity of the online conferences operated by the conferencing computing system 110 may change dynamically, as new online conferences begin, and as existing online conferences end.

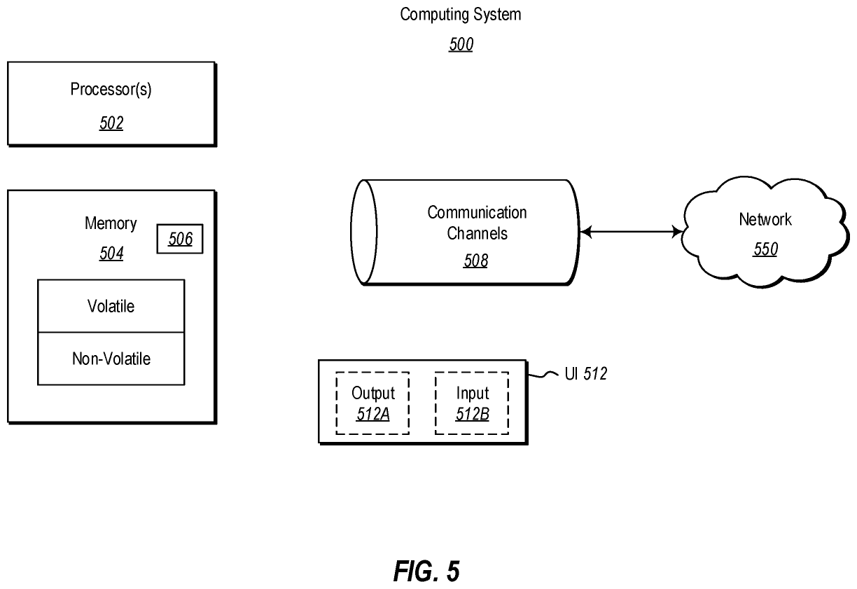

The conferencing computing system 110 also includes executable components 120 that support the online conferences (such as online conference 111) that are operated by the conferencing computing system 110. The conferencing computing system 110 may be structured as described below for the computing system 500 of FIG. 5. In that case, the online conference 111 and each of the executable components 120 may be structured as described below for the executable component 506 of FIG. 5. The executable components 120 are illustrated as including executable components 121 through 127, the behavior of each of which being described further below. That said, the ellipsis 128 represents that the principles described herein are not limited to the described executable components supporting the online conference 111.

In the illustrated example, the member users include member users B, C and D that are connected to the online conference 111 (as represented by respective connections 102, 103 and 104). However, the ellipsis E represents that the principles described herein are not limited to the number of member users in an online conference. In addition, the ellipsis E represents that even within a given online conference (such as online conference 111), the membership of the online conference may change dynamically, with member user(s) being added to, and removed from, the online conference over time. Each of these member users may connect to the online conference 111 using their respective client computing system. Each of those client computing systems may also be structured as described for the computing system 500 of FIG. 5. In that case, the connections between the member user's client computing system and the conferencing computing system 110 (represented by lines 102 through 104) may be one or more of the communication channels 508.

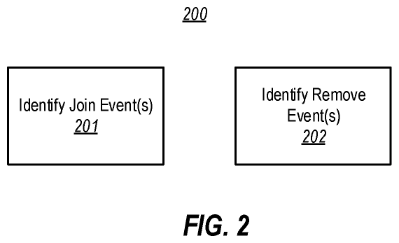

FIG. 2 illustrates a flowchart of a method 200 for managing join and remove events for a user. The method 200 may be performed for each user/conference pair. For instance, referring to FIG. 2, the method 200 may be performed for the user A with respect to online conference 111, for member user B with respect to online conference 111, for member user C with respect to online conference 111, and for member user D with respect to online conference 111.

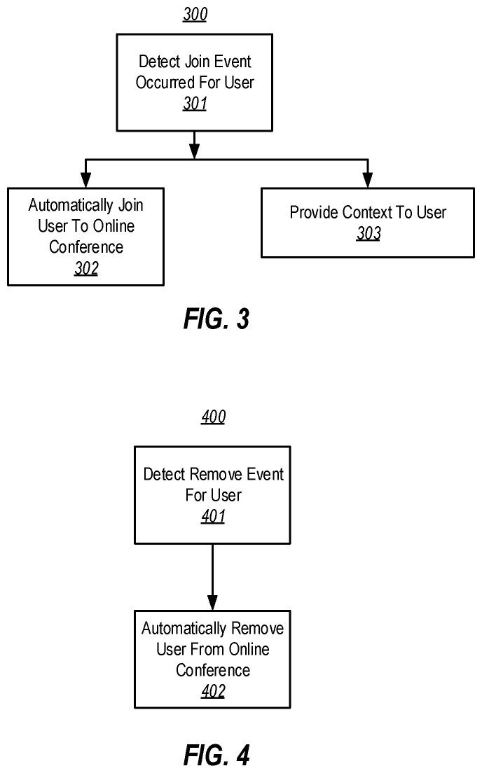

FIG. 3 illustrates a flowchart of a method 300 for joining a user into an online conference in response to an event such as the join events of FIG. 2, in accordance with the principles described herein. The method 300 may be performed for each user (e.g., user A) who may potentially join an online conference (such as online conference 111) to thereby become a member user of that online conference. FIG. 4 illustrates a flowchart of a method 400 for removing a member user from an online conference in response to an event, such as the remove event of FIG. 2, in accordance with the principles described herein. The method 400 may be performed for each member user (e.g., member user B, member user C, member user D, and potentially member user A after user A joins the online conference) who may potentially be removed from an online conference (such as online conference 111). Thus, the methods 300 and 400 may also be performed for each user/conference pair.

The methods 200, 300 and 400 may be performed by the conferencing computing system 110 in the context of the conferencing environment 100 of FIG. 1. Accordingly, the method 200 of FIG. 2, the method 300 of FIG. 3, and the method 400 of FIG. 4, will each be described with frequent reference to the conferencing environment 100 of FIG. 1.

Furthermore, the conferencing computing system 110 may be caused to perform the methods 200, 300 and 400 in response to one or more processors of the conferencing computing system 110 executing computer-executable instructions (that are on one or more computer-readable media) that are structured to, when executed, cause the conferencing computing system 110 to performed the respective method 200, 300 or 400. As an example, if the conferencing computing system 110 was structured as described for the computing system 500 of FIG. 5, the one or more processors may be the at least one hardware processing unit 502, and the one or more computer-readable media may be the memory 504.

FIG. 2 illustrates a flowchart of a method 200 for managing join and remove events for a user, in accordance with the principles described herein. As an example, with reference to FIG. 1, the method 200 may be performed in order to manage join and remove events for user A with respect to online conference 111. The method 200 includes identifying one or more conference join events that trigger automatically joining a user into an online conference (act 201), and identifying one or more conference remove events that trigger automatically removing a user from the online conference (act 202). As there is no temporal dependency between when join events and remove events are identified, the acts 201 and 202 are shown without flow arrows. In one embodiment, join and remove events may be defined in advance of the online conference, though remove events may potentially be defined for a particular user even after that user has joined an online conference. The method 200 may be performed by the event manager 121 of FIG. 1, which tracks join events 131 and remove events 132.

In addition, an event detector component 122 may be used to detect when the events managed by the event manager 121 have occurred. The principles described herein are not limited to any particular join event or join event type, or remove event or remove event type. However, examples will now be provided beginning with examples of join events.

Various sub-components may operate within the event detector component 122, depending on the types of events that are possible. The sub-components are illustrated as including sub-components 122A through 122E, the behavior of each of which being described further below. That said, the ellipsis 122F represents that the principles described herein are not limited to the described sub-components supporting the event detector component 122. The sub-components 122A through 122F may each be structured as described below for the executable component 506 of FIG. 5.

As for join events, the discussions of a particular topic (e.g., perhaps a topic relevant to the potential member user) within the online conference might be a join event. Various components may check when topics are being discussed. For instance, artificial intelligence can be employed to parse meaning from the online conference, to detect when topics are being discussed. Referring to FIG. 1, the artificial intelligence component 122A may be used for this purpose. Artificial intelligence might also be employed to allow for more general events, such as joining the user when the artificial intelligence itself judges that there is any topic being discussed that the user might be interested in.

Alternatively, or in addition to using artificial intelligence to identify that a topic is being discussed, an electronic agenda may be associated with the online conference, with an organizer of the online conference notifying when a particular agenda item has been reached. The agenda component 122B may be used to track where in the agenda the online conference currently stands.

Another join event example for a given user might be that the given user is mentioned in the online conference. A language component may be trained to listen and parse the words spoken at the online conference, such that mention of the user's name can be recognized. For instance, a language component 122C may parse and recognize the words being spoken in an online conference.

As another join event example, a user might be electronically summoned to the online conference. For instance, a supervisor might bring a user into an online meeting when the supervisor needs the help of that user. As another example, a user might instruct a staff member to electronically summon the user to the online conference upon something happening within the online conference. The summon component 122D may detect a summons for an online conference.

As another join event example, there might be that a particular speaker is speaking. For instance, a larger group of users might be automatically joined into an online conference once a president of a company begins speaking. Voice recognition may be employed to detect when a particular speaker speaks. The voice recognition component 122E may detect when a particular speaker's voice is being spoken.

As for remove events, in accordance with some embodiments, there might not be any remove events at all. For instance, once a user is automatically joined into an online conference, perhaps the member user is not removed until the online conference actually ends, and/or perhaps the member user manually exits the online conference. However, in accordance with embodiments described herein, there may be remove events that automatically trigger the removal of a member user from the online conference. In those cases, the principles described herein are also not limited to the type of remove events.

For instance, a remove event might be that a particular topic is being discussed, or is no longer being discussed. A remove event might be that the user is being released from the online conference (e.g., by an individual who summoned the user to the online conference). The remove event might be that the online conference has now moved beyond a particular agenda item, or perhaps that a particular speaker is no longer speaking.

In one embodiment, the join events may be at least partially defined by the user to which they apply. For instance, join event(s) that trigger the automatic joining of the user A into the online conference 111 may be set by the user A. Similarly, remove events may be at least partially defined by the user to which they apply. For instance, remove event(s) that trigger the automatic removal of the user A from the online conference 111 may be set by the user A.

Alternatively, or in addition, join event(s) and/or remove event(s) might be set, constrained, amended, and/or deleted by attendance policy. For instance, the policy component 123 in FIG. 1 may enforce attendance policy by setting, constraining, amending, and/or detecting one or more of the join event(s) 131 and/or one or more of the remove event(s) 132. As an example, in an all hands meeting for a company announcing an important acquisition, the attendance policy might be that all employees are to be automatically joined to the online conference.

Alternatively, or in addition, the join event(s) and remove event(s) might be regulated by an access control manager 124. For instance, a certain online conference might have a public meeting portion at the beginning, to be followed by a board meeting at the end. The access control manager 124 may remove all member users who are not board members from the online conference at the conclusion of the public meeting portion of the online conference. On the other hand, the access control manager 124 might have no restrictions on who can join the meeting during the public meeting portion of the online conference. Thus, prior to automatically joining the user into the online conference that is in progress, the access control manager 124 may be consulted to determine that the user is authorized to join the online conference. Also, prior to automatically removing the user from the online conference in progress, the access control manager 124 may be consulted to determined that the user is permitted to be removed from the online conference.

Although the join events and remove events have been described as being defined at the granularity of a user/conference pair, the principles described herein do not preclude defining join events or remove events more generally. For instance, a join or remove event may be applicable to multiple users (e.g., all employees of a company, all members of a division, all board members, all family members, and so forth). Furthermore, a join or remove event may be applicable to a single user across multiple conferences. For instance, a user might define a join event in which they are joined to any conference once their name is mentioned (subject perhaps to policy and access control restrictions). Finally, a join or remove event may be applicable to multiple users and across multiple conferences. For instance, there might be a remove event applicable to all board meetings removing any user who is not a board member upon detection that the board meeting has begun.

FIG. 3 illustrates a flowchart of a method 300 for joining a user into an online conference in response to a join event. As an example, the join event may be one of the join events 131 in FIG. 1, or one of the join events identified in act 201 of FIG. 2. The method 300 is initiated upon detecting a conference join event that occurs while the online conference is in progress and after the online conference has begun (act 301). As previously described, when the method 300 is performed by the conferencing computing system 110 of FIG. 1, this event detection may be performed by the event detection component 122.

In response to detecting the conference join event (act 301), the corresponding user is automatically joined into the online conference that is in progress (act 302). When the method 300 is performed by the conferencing computing system 110 of FIG. 1, this automatic joining may be performed by the join component 125. The join component 125 has access to all of the information to be used to join a user into an online conference. For instance, the join component 125 may know the online conference identifier, any access code or credentials for the online conference, any user credentials needed to authenticate the user, and an awareness of the specific protocol used to join a user into the online conference. The join component 125 follows that specific join protocol, and presents the information at the appropriate time, and in the appropriate form. Thus, the user is automatically joined into the online conference. This automatic joining may be over any protocol. Examples include Voice over IP (VoIP) or Packet Switched Telephone Network (PSTN).

It may take a few moments to join a user into the online conference once the join event is detected. Accordingly, in response to detecting the conference join event (act 303), the user might also be automatically provided with context of the online conference. When the method 300 is performed by the conferencing computing system 110 of FIG. 1, this may be performed by the context component 127. As an example, the context might be recorded or transcribed content of the online conference. As a more specific example, the recorded or transcribed content of the online conference might be for content that occurred from a time of the conference join event. This would allow the user to be brought up to speed on the content of the online from the point of the join event occurring, even if there is some lag between that join event, and the user actually being joined into the online conference.

FIG. 4 illustrates a flowchart of a method 400 for removing a member user from an online conference in response to an event. As an example, the remove event may be one of the remove events 132 in FIG. 1, or one of the remove events identified in act 202 of FIG. 2. The method 400 is initiated upon detecting a conference remove event that occurs while the online conference is in progress and after the online conference has begun (act 401). As previously described, when the method 400 is performed by the conferencing computing system 110 of FIG. 1, this event detection may be performed by the event detection component 122.

In response to detecting the conference remove event (act 301), the corresponding user is automatically removed from the online conference that is in progress (act 402). When the method 400 is performed by the conferencing computing system 110 of FIG. 1, this automatic removal may be performed by the removal component 126. The removal might be as simple as disconnecting the connection between the online conference and the user's client computing system. Other actions might be additionally taken prior to or subsequent to disconnecting the user's computing system. For instance, the user might be provided with a recording, transcription, and or shared documents of the portion of the online conference that the user was permitted to attend.

Accordingly, the principles described herein provide a mechanism for automatically joining a user into an online conference in response to a join event, and potentially also removing a user from the online conference in response to a remove event. This alleviates the user from having to manually join an online conference, which can be cumbersome. This also allows for defining of predetermined times and events that trigger a user to be joined or removed from an online conference, ensuring that the purposes of the online conference are better met. Finally, some embodiments described herein allow for context to be provided to the user in conjunction with joining an online conference, thus allowing the user to be brought up to speed on the online conference.

As the principles described herein may be enabled via the use of computing systems, an example computing system will now be described with respect to FIG. 5. Computing systems are now increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses, watches, bands, and so forth). In this description and in the claims, the term “computing system” is defined broadly as including any device or system (or combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 5, in its most basic configuration, a computing system 500 typically includes at least one hardware processing unit 502 and memory 504. The memory 504 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 500 has thereon multiple structures often referred to as an “executable component”. For instance, the memory 504 of the computing system 500 is illustrated as including executable component 506. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the term “component” may also be used. As used in this description and in the case, this term (regardless of whether the term is modified with one or more modifiers) is also intended to be synonymous with the term “executable component” or be specific types of such an “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data.

The computer-executable instructions (and the manipulated data) may be stored in the memory 504 of the computing system 500. Computing system 500 may also contain communication channels 508 that allow the computing system 500 to communicate with other computing systems over, for example, network 510.

While not all computing systems require a user interface, in some embodiments, the computing system 500 includes a user interface 512 for use in interfacing with a user. The user interface 512 may include output mechanisms 512A as well as input mechanisms 512B. The principles described herein are not limited to the precise output mechanisms 512A or input mechanisms 512B as such will depend on the nature of the device. However, output mechanisms 512A might include, for instance, speakers, displays, tactile output, holograms, virtual reality, and so forth. Examples of input mechanisms 512B might include, for instance, microphones, touchscreens, holograms, virtual reality, cameras, keyboards, mouse or other pointer input, sensors of any type, and so forth.

Embodiments described herein may comprise or utilize a special purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example, and not limitation, embodiments can comprise at least two distinctly different kinds of computer-readable media: storage media and transmission media.

Computer-readable storage media include RAM, ROM, EEPROM, CD-ROM or other optical disk storage, magnetic disk storage or other magnetic storage devices, or any other physical and tangible storage medium which can be used to store desired program code means in the form of computer-executable instructions or data structures and which can be accessed by a general purpose or special purpose computing system.

A “network” is defined as one or more data links that enable the transport of electronic data between computing systems and/or components and/or other electronic devices. When information is transferred or provided over a network or another communications connection (either hardwired, wireless, or a combination of hardwired or wireless) to a computing system, the computing system properly views the connection as a transmission medium. Transmissions media can include a network and/or data links which can be used to carry desired program code means in the form of computer-executable instructions or data structures and which can be accessed by a general purpose or special purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface component (e.g., a “NIC”), and then eventually transferred to computing system RAM and/or to less volatile storage media at a computing system. Thus, it should be understood that readable media can be included in computing system components that also (or even primarily) utilize transmission media.

Computer-executable instructions comprise, for example, instructions and data which, when executed at a processor, cause a general purpose computing system, special purpose computing system, or special purpose processing device to perform a certain function or group of functions. Alternatively, or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses or watches) and the like. The invention may also be practiced in distributed system environments where local and remote computing systems, which are linked (either by hardwired data links, wireless data links, or by a combination of hardwired and wireless data links) through a network, both perform tasks. In a distributed system environment, program components may be located in both local and remote memory storage devices.

Those skilled in the art will also appreciate that the invention may be practiced in a cloud computing environment, which is supported by one or more datacenters or portions thereof. Cloud computing environments may be distributed, although this is not required. When distributed, cloud computing environments may be distributed internationally within an organization and/or have components possessed across multiple organizations.

In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

For instance, cloud computing is currently employed in the marketplace so as to offer ubiquitous and convenient on-demand access to the shared pool of configurable computing resources. Furthermore, the shared pool of configurable computing resources can be rapidly provisioned via virtualization and released with low management effort or service provider interaction, and then scaled accordingly.

A cloud computing model can be composed of various characteristics such as on-demand, self-service, broad network access, resource pooling, rapid elasticity, measured service, and so forth. A cloud computing model may also come in the form of various application service models such as, for example, Software as a service (“SaaS”), Platform as a service (“PaaS”), and Infrastructure as a service (“IaaS”). The cloud computing model may also be deployed using different deployment models such as private cloud, community cloud, public cloud, hybrid cloud, and so forth. In this description and in the claims, a “cloud computing environment” is an environment in which cloud computing is employed.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A computing system comprising:
one or more processors; and
one or more computer-readable media having thereon computer-executable instructions that are executable by the one or more processors to cause the computing system to perform a method for joining a user into an online conference automatically in response to an event, and by at least configuring the computing system to perform the following:
identify one or more conference join events that trigger automatically joining the user into the online conference;
detect at least one conference join event that occurs while the online conference is in progress and after the online conference has begun;
in response to detecting the at least one conference join event, access information to be used to automatically join the user into the online conference;
identifying a specific join protocol for the user based on the accessed information; and
performing the specific join protocol to automatically join the user into the online conference that is in progress.

2. The computing system in accordance with claim 1, the one or more conference join events being at least partially defined by the user.

3. The computing system in accordance with claim 1, the one or more conference join events being at least partially defined by attendance policy.

4. The computing system in accordance with claim 1, the one or more conference join events being regulated by access control for the online conference.

5-8. (canceled)

9. The computing system in accordance with claim 1, the conference join event being that a particular topic is discussed in the online conference.

10. The computing system in accordance with claim 1, the conference join event being that a topic relevant to the user is discussed in the online conference.

11. The computing system in accordance with claim 1, the conference join event being that a particular agenda item has been reached in the online conference.

12. The computing system in accordance with claim 1, the conference join event being that a particular speaker has begun speaking.

13. (canceled)

14. The computing system in accordance with claim 1, the computer-executable instructions being further configured to cause the computing system to perform the following:
identify one or more conference remove events that trigger automatically removing a user from the online conference;
detect a conference remove event that occurs while the online conference is in progress and after the user has been automatically joined into the online conference; and
in response to detecting the conference remove event, automatically remove the user from the online conference that is in progress.

15. The computing system in accordance with claim 14, the one or more conference remove events being at least partially defined by the user.

16. The computing system in accordance with claim 14, the one or more conference remove events being at least partially defined by access control for the online conference.

17. The computing system in accordance with claim 1, the computer-executable instructions being further configured to cause the computing system to determine that the user is authorized to join the online conference prior to automatically joining the user into the online conference that is in progress.

18. A method for joining a user into an online conference automatically in response to an event, the method comprising:
identifying one or more conference join events that trigger automatically joining the user into the online conference;
detecting a conference join event that occurs while the online conference is in progress and after the online conference has begun;
in response to detecting the conference join event, accessing information to be used to automatically join the user into the online conference;
identifying a specific join protocol for the user based on the accessed information; and
performing the specific join protocol to automatically join the user into the online conference that is in progress.

19. The method in accordance with claim 18, further comprising:
automatically providing the user with context of the online conference in response to detecting the conference join event.

20. A computer program product comprising one or more computer-readable hardware storage devices having thereon computer-executable instructions that are executable by one or more processors of a computing system to cause the computing system to perform a method for joining a user into an online conference automatically in response to an event, and by at least configuring the computing system to perform the following:
identify one or more conference join events that trigger automatically joining the user into the online conference;
detect a conference join event that occurs while the online conference is in progress and after the online conference has begun;
in response to detecting the conference join event, access information to be used to automatically join the user into the online conference; identifying a specific join protocol for the user based on the accessed information; and performing the specific join protocol to automatically join the user into the online conference that is in progress.

21. The computing system in accordance with claim 1, wherein the specific join protocol comprises at least one of a conference identifier, an access code, or a user credential necessary to authenticate the user.

22. The computing system in accordance with claim 1, wherein the user is one of group of users that is automatically joined in response to a common join event.

23. The computing system in accordance with claim 1, the computer-executable instructions being further configured to cause the computing system to use a language component that is trained to parse words spoken in the online conference to identify a mention of the user's name in the words spoken in the online conference, wherein the at least one conference join event comprises the computing system identifying the mention of the user's name in the words spoken in the online conference.

24. The computing system in accordance with claim 23, the computer-executable instructions being further configured to cause the computing system to, in response to detecting the at least one conference join event, generate and provide the user a recording or transcript of a portion of the online conference that occurs subsequent to detecting the conference join event and corresponding to a time of the automatically joining of the user into the online conference.

25. The method of claim 18, the method further including:
the computing system identifying a mention of the user's name in the words spoken in the online conference by using a language component that is trained to parse words spoken in the online conference, wherein the at least one conference join event comprises the computing system identifying the mention of the user's name in the words spoken in the online conference; and
the computing system, in response to detecting the at least one conference join event, generating and providing the user a recording or transcript of a portion of the online conference that occurs subsequent to detecting the conference join event.

26. The computer program product of claim 14, the computer-executable instructions being further configured to cause the computing system to perform the following:
use a language component that is trained to parse words spoken in the online conference to identify a mention of the user's name in the words spoken in the online conference, wherein the at least one conference join event comprises the computing system identifying the mention of the user's name in the words spoken in the online conference; and
in response to a detection of the at least one conference join event, to generate and provide the user a recording or transcript of a portion of the online conference that occurs proximate a time of the automatically joining of the user into the online conference.
